(19) United States
(12) Patent Application Publication
(10) Pub. No.: US 2008/0045070 A1
(43) Pub. Date: Feb. 21, 2008

(54) Electrical connector with improved locking arms

(75) Inventors: Qi-Sheng Zheng, Kunshan (CN); Jia-Yong He, Kunshan (CN); Zhong-Hua Yao, Kunshan (CN); Wen-Yu Liu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND., LTD.

(21) Appl. No.: 11/894,132

(22) Filed: Aug. 20, 2007

(30) Foreign Application Priority Data
Aug. 18, 2006 (CN) 200620077165.X
Aug. 18, 2006 (CN) 200620077166.4

(51) Int. Cl. H01R 13/62

(52) U.S. Cl. 439/370; 439/296; 439/607

(57) ABSTRACT

An electrical connector (100) for receiving a camera module (5) includes an insulative housing (1), a number of contacts (2) retained in the insulative housing and a metal shield (4) covering the insulative housing. The insulative housing (1) includes first and second side walls (13, 14) with a receiving chamber (10) formed therebetween. Either the first or the second side wall includes a pair of elastic locking arms (131) integrally extending therefrom. The locking arms extend into the receiving chamber for abutting against the camera module.

### BACKGROUND OF THE INVENTION

1. Field of the Invention

The present invention relates to electrical connectors, and more particularly to an electrical connector with improved locking arms for abutting against an electronic module accommodated in the electrical connector.

2. Description of Related Art

With development trend of miniature and multifunctional electronic devices, consumer electronic devices such as cell phones, personal digital assistants etc., are designed to provide camera module for capturing pictures. Accordingly, there is a demand employing socket connectors for connecting the camera module to the consumer electronic devices.

U.S. Pat. No. 7,086,902 B1, issued on Aug. 8, 2006, discloses such a conventional socket connector. The socket connector comprises an insulative housing, a plurality of contacts retained in the insulative housing and a metal shield enclosing the insulative housing to form a chamber for receiving a camera module therein. The plurality of contacts comprise a plurality of contact portions protruding into the chamber. The metal shield comprises a pair of opposite shielding walls each of which comprises three engaging arms integrally bending from an edge thereof and extending into the chamber for holding the camera module received in the chamber. However, since the engaging arms are long and integrally bend from the metal shield, the structure of the metal shield is complex and difficult in manufacture. Besides, it is difficult to provide a precise assembly when the camera module is inserted into the chamber.

Hence, an improved electrical connector is desired to overcome the above problems.

### BRIEF SUMMARY OF THE INVENTION

It is an object of the present invention to provide an electrical connector for accurately receiving an electronic module therein.

In order to obtain the object above, an electrical connector for receiving an electronic module therein comprises an insulative housing, a plurality of contacts retained in the insulative housing and a metal shield covering the insulative housing. The insulative housing includes a pair of first and second side walls with a receiving chamber therebetween for accommodating the electronic module. The first and the second side walls respectively include first and second elastic locking arms on inner sides thereof. The first and the second locking arms integrally extend from the first and the second side walls and protrude into the receiving chamber for abutting against the electronic module. The contacts comprise a plurality of contact portions extending into the receiving chamber for mating with the inserted electronic module. Since the locking arms are integrally molded with the first and the second side walls, it is easy that the locking arms occur same elasticity with insertion of the electronic module in order to provide excellent mounting precision. As a result, the electronic module can be received in the receiving chamber accurately.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector assembly with an electronic module received in an electrical connector according to a first embodiment of the prevent invention;

FIG. 2 is an exploded perspective view of the electrical connector assembly;

FIG. 3 is another exploded view similar to FIG. 2, but viewed from another aspect;

FIG. 4 is a cross-sectional view of the electrical connector assembly taken along line 4-4 of FIG. 1;

FIG. 4 is an enlarged view of a circle portion as shown in FIG. 2;

FIG. 6 is a perspective view of an electrical connector assembly with an electronic module received in an electrical connector according to a second embodiment of the prevent invention;

FIG. 7 is an exploded perspective view of the electrical connector assembly according to the second embodiment;

FIG. 8 is another exploded view similar to FIG. 7, but viewed from another aspect; and

FIG. 9 is a cross-sectional view of the electrical connector assembly taken along line 9-9 of FIG. 6.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

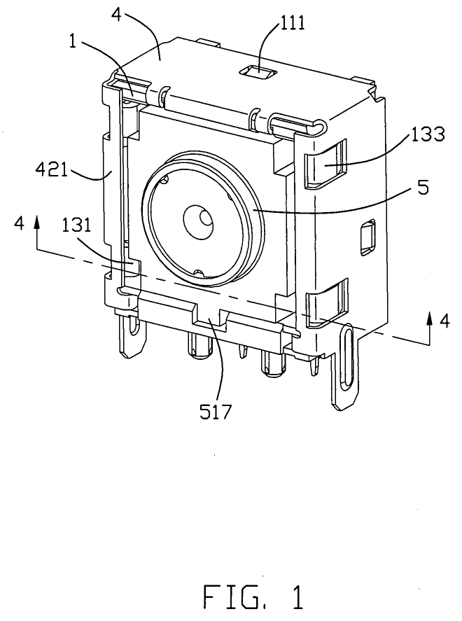

Referring to FIGS. 1-5, an electrical connector 100 according to a first embodiment is applicable to a mobile handset device (not shown) for electrically receiving an electronic module (such as a camera module 5) thereinto. The electrical connector 100 includes a rectangular insulative housing 1, a plurality of contacts 2 retained in the insulative housing 1 and a metal shield 4 covering the insulative housing 1.

The insulative housing 1 comprises four continuous walls with a receiving chamber 10 formed therebetween and a rear wall 15 in the rear end of the receiving chamber 10. The four continuous walls consist of a first side wall 13, a second side wall 14 opposite to the first side wall 13, a top wall 11 and a bottom wall 12. The top wall 11 connects upper edges of the first and second side walls 13 and 14. The bottom wall 12 connects lower edges of the first and second side walls 13 and 14. The top wall 11 comprises a protrusion 111 on an outer surface thereof for mating with the metal shield 4. The bottom wall 12 defines a recess 121 in an inner surface thereof. The recess 121 communicates with the receiving chamber 10 for mating with a corresponding protrusion 517 formed on the camera module 5 so that the camera module 5 can be correctly received in the receiving chamber 10. The bottom wall 12 is mounted to a circuit board (not shown) of the mobile handset device through a plurality of posts 123 which extend downwardly from the bottom wall 12. The second side wall 14 is of the same configuration as the first side wall 13, in order to simplify description, only the first side wall 13 is taken for example. The first side wall 13 comprise a pair of first elastic locking arms 131 integrally extending from an out edge 130 thereof and extending backwardly into the receiving chamber 10. The pair of locking arms 131 are located on opposite sides of the first side wall 13. The inner side of the first side wall defines a pair of recesses 132 corresponding to the pair of locking arms 131 so that the locking arms 131 can provide excellent elasticity. The pair of locking arms 131 can be elastically movable in the corresponding recesses 132 with insertion of the camera module 5. Each locking arm 131 comprises a protrusion 134 on a distal end thereof for locking with the camera module 5 in order to prevent it from falling out of the electrical connector 100. In order to hold the camera module 5 stably in the receiving chamber 10, the protrusion 134 is ablated a small part to form a retaining surface 1311 and a restricting surface 1313 perpendicular to the retaining surface 1311 as best shown in FIG. 5. The rear wall 15 and the bottom wall 12 define a plurality of passageways 151, 124, respectively, for receiving the contacts 2.

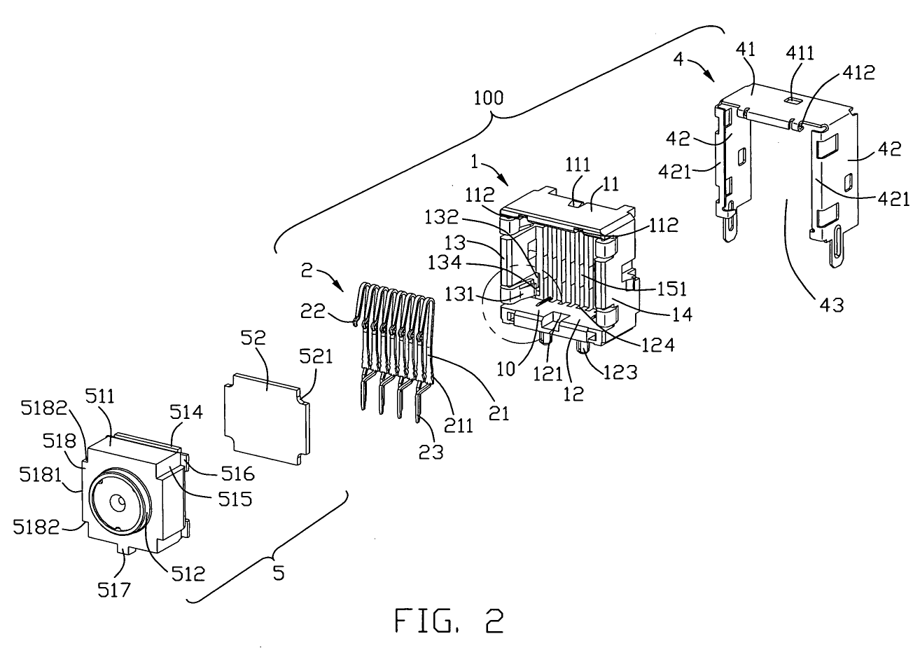

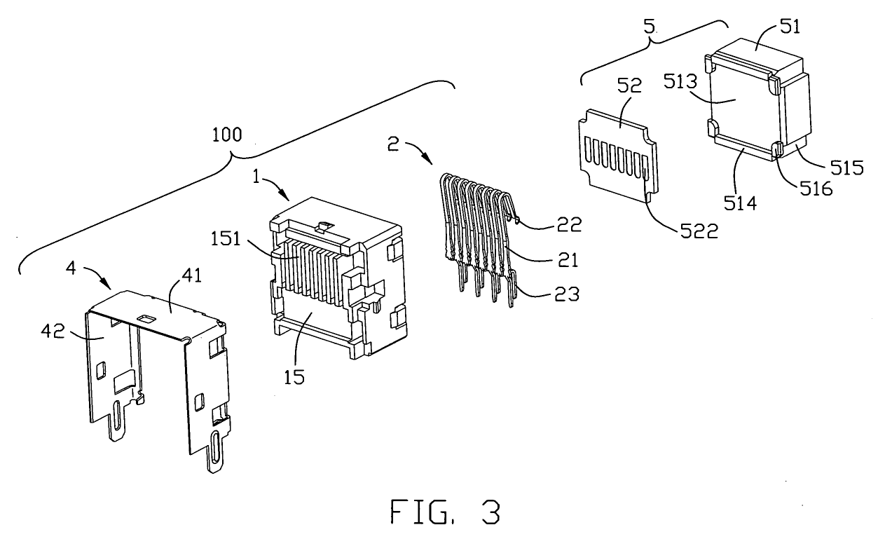

Referring to FIGS. 2-3, the contacts 2 are received in the corresponding passageways 151, 124 from a lower-to-upper direction. Each contact 2 comprises a body 21, an elastic contact portion 22 bending downwardly from one end of the body 21 and a L-shaped tail 23 extending from the other end of the body 21. The body 21 comprises a plurality of barbs 211 so that the contacts 2 can be stably retained in the insulative housing 1. The contact portion 22 of each contact 2 cantileveredly extends into the receiving chamber 10 for electrically connecting with the camera module 5.

The metal shield 4 is stamped from an integral metal sheet and comprises a top face 41, a pair of side faces 42 extending downwardly from lateral edges of the top face 41 and a cavity 43 disposed between the side faces 42. The top face 41 defines a receiving hole 411 for receiving the protrusion 111 of the insulative housing 1. A plurality of hooks 412 bend from a front edge of the top face 41 and extend backwardly into the cavity 43. When the metal shield 4 is assembled to the insulative housing 1, the hooks 412 are received in corresponding apertures 112 recessed in the top wall 11 of the insulative housing 1. Each side face 42 further has a holding plate 421 bending laterally from a front edge thereof and substantially perpendicular to the side face 42. When the metal shield 4 is assembled to enclose the insulative housing 1, the holding plates 421 of the side faces 42 abut against the out edges 130 of the first and the second side walls 13, 14. Under this circumstance, the metal shield 4 is easily to be manufactured. Besides, since the locking arms 131 are integrally molded with the first and the second side walls 13, 14, it is easy that locking arms 131 occur same elasticity with insertion of the camera module 5 in order to provide excellent mounting precision.

The camera module 5 includes a base portion 511, a column lens portion 512 protruding from the base portion 511 and a circuit board 52 attached to a rear side 514 of the base portion 511. The rear side 514 defines a depression 513 to receive the circuit board 52 so that the circuit board is coplanar with the rear side 514 of the base portion 511. The circuit board 52 comprises a plurality of conductive pads 522 as shown in FIG. 3. The base portion 511 comprises four locking plates 516 formed on four corners of the rear side 514 and four guiding grooves 515 corresponding to the four locking plates 516. The base portion 511 further comprises a pair of projections 518 on lateral sides thereof. Each projection 518 comprises an out surface 5181 parallel to the first and the second side walls 13, 14 and a pair of locking surfaces 5182 in communication with the corresponding guiding grooves 515.

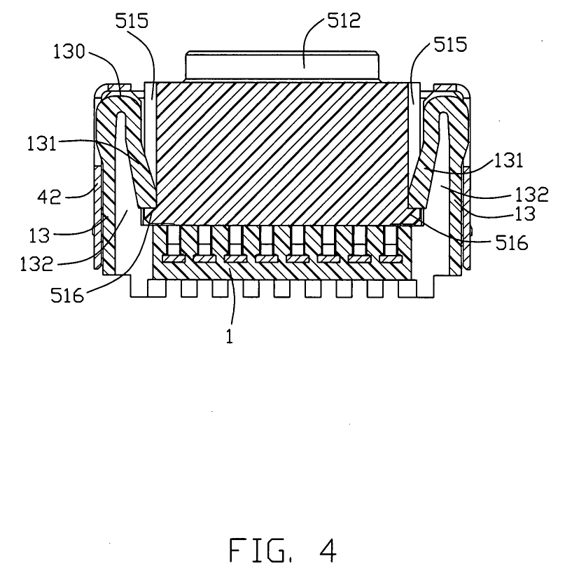

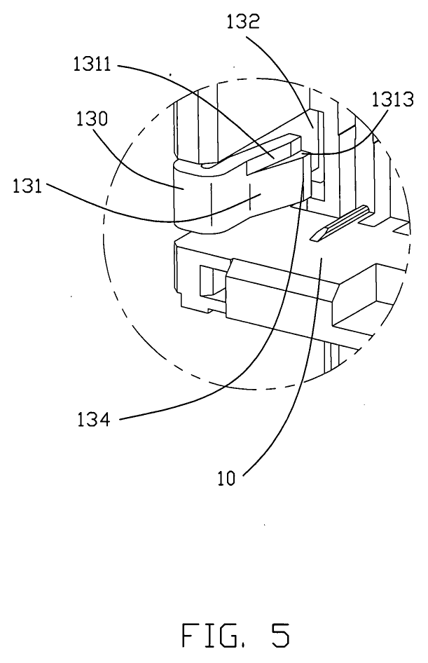

When the camera module 5 is inserted into the receiving chamber 10 of the insulative housing 1, the locking plates 516 abut against the locking arms 131 of the insulative housing 1 to make the locking arms 131 deformable in the corresponding recesses 132. After the camera module 5 is inserted into a rear end of the receiving chamber 10, the contact portions 22 of the contacts 2 attach the conductive pads 522 of the circuit board 52. Meanwhile, the locking arms 131 resume their elasticity to be located in corresponding guiding grooves 515. The distal ends of the locking arms 131 abut against the locking plates 516 as best shown in FIG. 4 so that the camera module 5 can't fall off from the receiving chamber 10. Besides, the out surface 5181 of the camera module 5 mates with the retaining surface 1311 of the locking arm 131 and the locking surfaces 5182 abut against the corresponding restricting surfaces 1313 of the locking arm 131. As a result, the camera module 5 is clipped between the pair of restricting surfaces 1313 of the locking arms 131, thereby the camera module 5 is stably received in the receiving chamber 10 in a vertical direction.

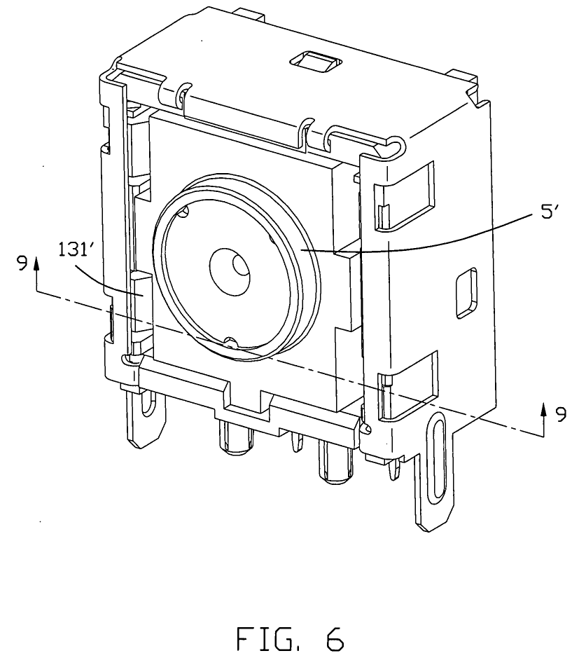

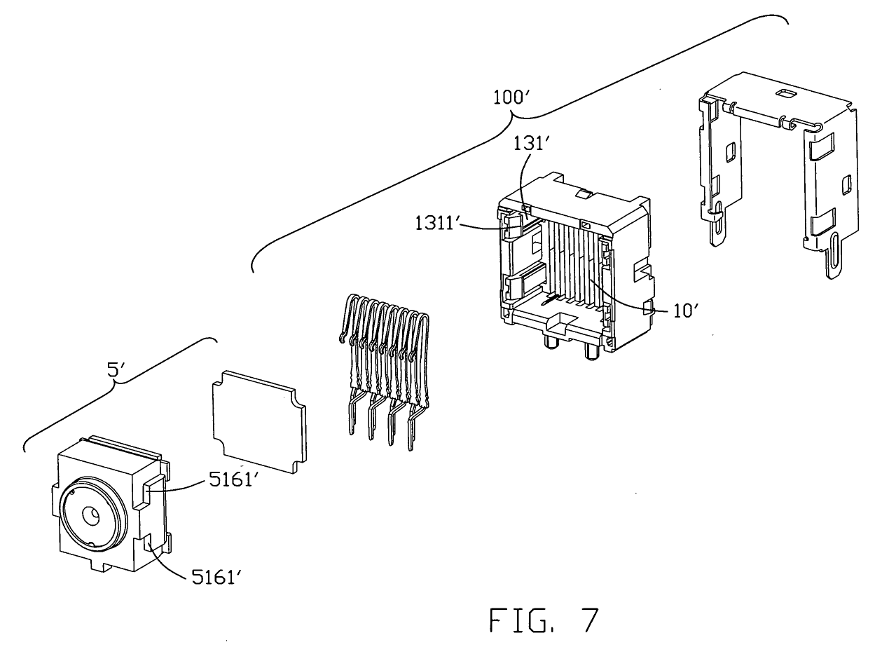

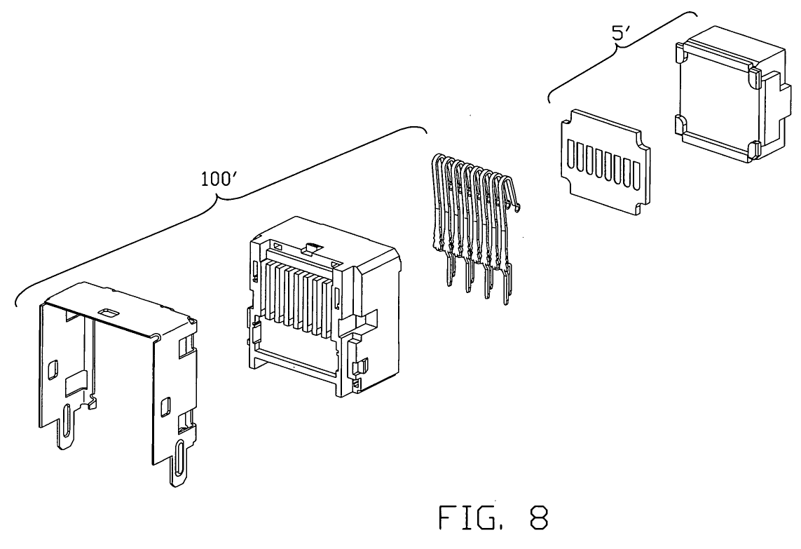

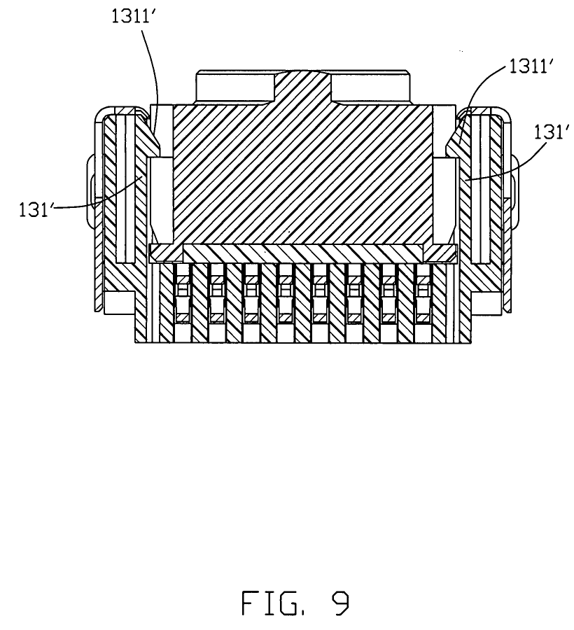

Please refer to FIGS. 6-9, a second embodiment is provided of the present invention. An electrical connector 100′ which is similar to the electrical connector 100 of the first embodiment wherein the differences between them are that each elastic locking arm 131′ of the electrical connector 100′ extends in a direction against an insertion direction of a camera module 5′. The locking arm 131′ comprises a hook 1311′ on a distal end thereof. The camera module 5′ comprise a plurality of locking plates 5161′ corresponding to the hook 1311′. When the camera module 5′ is inserted into a receiving chamber 10′, the hooks 1311′ lock with corresponding locking plates 5161′ so that the camera module 5′ can be held in the receiving chamber 10′ as best shown in FIG. 10.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector for receiving an electronic module therein, comprising:
an insulative housing comprising a first side wall and a second side wall opposite to the first side wall with a receiving chamber formed therebetween for receiving the electronic module, the first and the second side walls respectively comprising a first and a second elastic locking arms on inner sides thereof, wherein the first and the second locking arms integrally extend from the first and the second side walls and protrude into the receiving chamber for abutting against the electronic module; and
a plurality of contacts retained in the insulative housing, the contacts comprising a plurality of contact portions extending into the receiving chamber.

2. The electrical connector according to claim 1, wherein the inner sides of the first and the second side walls respectively define first and second recesses, the first and the second locking arms being elastically movable in the first and the second recesses, respectively.

3. The electrical connector according to claim 2, wherein the first and the second locking arms are made of insulative material.

4. The electrical connector according to claim 2, wherein the first and the second locking arms extend backwardly from out edges of the first and the second side walls, the first and the second locking arms comprising first and second protrusions disposed on distal ends thereof, respectively, and wherein the first and the second protrusions protruding into the receiving chamber for abutting against the electronic module.

5. The electrical connector according to claim 2, wherein the first and the second elastic locking arms comprise first and second hooks adjacent to out edges of the first and the second side walls, the first and the second hooks protruding into the receiving chamber for locking with the electronic module.

6. The electrical connector according to claim 1, wherein the first and the second side walls comprise another first and second elastic locking arms on the inner sides thereof, respectively, and wherein the first and the another first elastic locking arms are located on opposite sides of the first side wall, the second and the another second elastic locking arms being located on opposite sides of the second side wall.

7. The electrical connector according to claim 1, wherein the insulative housing comprises a rear wall located in the receiving chamber to retain the plurality of contacts.

8. The electrical connector according to claim 7, wherein the plurality of contacts are assembled to the insulative housing from a lower-to-upper direction, each contact comprising a body received in the rear wall and a tail extending from one end of the body, and wherein the contact portion of each contact bends downwardly from the other end of the body.

9. The electrical connector according to claim 1, wherein the insulative housing is squared shaped and comprises a top wall connecting top ends of the first and second side walls, and a bottom wall connecting bottom ends of the first and second side walls with the receiving chamber formed between the top and bottom walls.

10. An electrical connector assembly, comprising:
an electronic module having a base portion, a column lens portion protruding from the base portion and a plurality of conductive pads; and
an electrical connector comprising:
an insulative housing comprising a first side wall and a second side wall opposite to the first side wall with a receiving chamber formed therebetween to receive the electronic module, the first and the second side walls respectively comprising a first and a second elastic locking arms on inner sides thereof, wherein the first and the second locking arms integrally extend from the first and the second side walls and protrude into the receiving chamber to lock with the electronic module; and
a plurality of contacts retained in the insulative housing, the contacts comprising a plurality of contact portions extending into the receiving chamber to mate with the conductive pads.

11. The electrical connector assembly according to claim 10, wherein the inner sides of the first and the second side walls respectively define first and second recesses, the first and the second locking arms being elastically movable in the first and the second recesses, respectively, with insertion of the electronic module.

12. The electrical connector assembly according to claim 11, wherein the first and the second locking arms comprise first and second protrusions disposed on distal ends thereof, respectively, and wherein the first and the second protrusions protruding into the receiving chamber to lock with the electronic module.

13. The electrical connector assembly according to claim 12, wherein the first and the second side walls comprise another first and second elastic locking arms on the inner sides thereof, respectively, and wherein the first and the another first elastic locking arms are located on opposite sides of the first side wall, the second and the another second elastic locking arms being located on opposite sides of the second side wall.

14. The electrical connector assembly according to claim 13, wherein the base portion comprises a pair of guiding depressions on opposite sides thereof and a pair of locking plates communicating with the pair of guiding depressions, respectively, and wherein the pair of locking plates abutting against the distal ends of the first and the another first locking arms.

15. The electrical connector assembly according to claim 14, wherein the base portion comprises a projection between the pair of guiding depressions, the projection comprising an out surface parallel to the first side wall and a locking surface perpendicular to the out surface, the protrusion of the first locking arm being ablated a small part to form a retaining surface to mate with the out surface and a restricting surface to mate with the locking surface.

16. An electrical connector assembly:
an insulative upstanding housing defining a receiving cavity surrounded by a plurality of side walls under a condition that said receiving cavity is sideward open to an exterior;
a plurality of contacts disposed in the housing and having contacting portions extending into the receiving cavity, and tail sections extending below the corresponding contacting sections;
a metallic shield enclosing said housing and covering said side walls; and
an electronic module received in the receiving cavity; wherein
a resilient latching arm is integrally formed with the housing and locking the electronic module in position in the receiving cavity.

17. The electrical connector as claimed in claim 16, wherein said latching arm is deflectable about a fulcrum axis extending in an upstanding direction.

18. The electrical connector as claimed in claim 16, wherein said shield defines an opening to allow outward deflection of the latching arm.
